(19) United States
(12) Patent Application Publication
(10) Pub. No.: US 2004/0179185 A1
(43) Pub. Date: Sep. 16, 2004

(54) Optical fixed-distance sensing apparatus

(76) Inventors: Her-Ting Wei, Taoyuan Hsien (TW); Xin-Zhi Luo, Pingjhen City (TW)

Correspondence Address: J.C. Patent, Inc., Suite 250, 4 Venture, Irvine, CA, 92618, US

(21) Appl. No.: 10/753,723

(22) Filed: Jan. 8, 2004

(30) Foreign Application Priority Data
Mar. 12, 2003 (TW) 92133981

(51) Int. Cl. G01C 3/00; G01C 3/08; G01C 5/00

(52) U.S. Cl. 356/3.04; 356/3.03

(57) ABSTRACT

An optical fixed-distance sensing apparatus comprising a light source, a receiving lens, a light-shielding plate and a photo sensor is provided. The light source is adapted to project a beam of light upon an object and get a reflected beam therefrom. The receiving lens is set up at a point along the beam path after the object. The light shielding plate comprises an aperture located at the focal point of the receiving lens. The photo sensor is set up at a point along the beam path after the light shielding plate.

### BACKGROUND OF THE INVENTION

1. Field of the Invention

The present invention relates to an optical fixed-distance sensing apparatus. More particularly, the present invention relates to a design for increasing the measuring precision of an optical fixed-distance sensing apparatus.

2. Description of the Related Art

With great advance in electronic technologies, optical fixed-distance sensing apparatus have found an ever-expanding list of applications in our daily life. At present, the optical fixed-distance sensing apparatus can be roughly classified into short distance sensing and long distance sensing devices. In general, the sensing range of a short distance optical fixed-distance sensing apparatus is set between 10 dm to 50 dm. The short distance optical fixed-distance sensing apparatus is often used inside a car reversing radar, a collision prevention detector, an anti-theft system, an automatic flushing unit in a sanitation system, a hand dryer or an entrance announcer in a shop.

FIG. 1 is a side view of a conventional short distance optical fixed-distance sensing apparatus. As shown in FIG. 1, the short distance optical fixed-distance sensing apparatus mainly comprises a light source 110, a collimating lens 120, a receiving lens 130 and a photo sensor 140. The light source 110 is adapted to project a beam of light 112. The light beam 112 passes through the collimating lens 120, travels to an object 200 and gets reflected therefrom. The receiving lens 130 is set up at a point along the path of the light beam 112 after the object 200 for intercepting the reflected light beam. The photo sensor 140 is also set up at a point along the path of the light beam 112 after the receiving lens 130 to intercept the light beam 112 from the receiving lens 130.

It should be noted that the photo sensor 140 is set up at the focal point of the receiving lens 130. In other words, the distance from the receiving lens 130 to the photo sensor 140 is the focal length F of the receiving lens 130.

FIG. 2 is a schematic diagram showing the light path of a conventional short distance optical fixed-distance sensing apparatus. As shown in FIGS. 1 and 2, if the optical fixed-distance sensing apparatus 100 is set to measure a distance X, the angle of reception of the receiving lens 130 will produce a measurement with an error range ΔX. In theory, if the measured distance is set to X while the object 200 is located at position B, the photo sensor 140 will detect the strongest signal level V_{B}. Conversely, if the measured distance is set to X while the object 200 is located at position A or C, the photo sensor 140 will detect a signal level V_{A} or V_{C} smaller than V_{B}.

Because positions A, B and C all fall within the same error range ΔX, the variation in signal level between V_{A}, V_{B} and V_{C} is small. With a small difference in signal level between position A, B and C, it is difficult to determine the correct position of the object 200. In other words, the photo sensor 140 is able to detect an incorrect position only when the object 200 is placed outside the measured error range ΔX. At present, an optical fixed-distance sensing apparatus 100 with a sensing distance between 10 dm to 15 dm has a measured error range ΔX of about ±3 dm (an error of between 20% to 33%). Hence, the sensitivity and measuring precision of most conventional optical fixed-distance sensing apparatus 100 is at the low end of the scale.

### SUMMARY OF THE INVENTION

Accordingly, at least one objective of the present invention is to provide an optical fixed-distance sensing apparatus capable of reducing distance-fixing error so that measuring precision and sensitivity is increased.

To achieve these and other advantages and in accordance with the purpose of the invention, as embodied and broadly described herein, the invention provides an optical fixed-distance sensing apparatus. The apparatus comprises a light source, a receiving lens, a light-shielding plate and a photo sensor. The light source is adapted to project a beam of light upon an object and get a reflected beam therefrom. The receiving lens is set up at a point along the beam path after the object. The light shielding plate has an aperture located at the focal point of the receiving lens. The photo sensor is set up at a point along the beam path after the light shielding plate.

According to the optical fixed-distance sensing apparatus of the present invention, the light source is a laser diode.

According to the optical fixed-distance sensing apparatus of the present invention, the sectional profile of the light beam at the focal point of the receiving lens is identical to the shape of the aperture. The aperture has a circular, polygonal or other geometric shape, for example.

According to the optical fixed-distance sensing apparatus of the present invention, the photo sensor is a photodiode, a charge-coupled device (CCD) or a complementary metal-oxide-semiconductor (CMOS) image sensor, for example.

According to the embodiment of the present invention, the optical fixed-distance sensing apparatus further comprises a collimator set up between the light source and the object. In addition, the collimator according to this embodiment is a collimating lens, for example.

In the present invention, a light-shielding plate is set up between the receiving lens and the photo sensor. The light-shielding plate has an aperture therein set up at the focal point of the receiving lens. Hence, distance-fixing error can be greatly reduced so that precision of measurement of the optical fixed-distance sensing apparatus is improved.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a side view of a conventional short distance optical fixed-distance sensing apparatus.

FIG. 2 is a schematic diagram showing the light path of a conventional short distance optical fixed-distance sensing apparatus.

FIG. 3 is a side view of a short distance optical fixed-distance sensing apparatus according to one preferred embodiment of present invention.

FIGS. 4A, 4B and 4C show the relationship between the light-shielding plate and the light beam when the object in FIG. 3 is positioned at location B, location A and location C respectively.

FIG. 5 is a graph showing the relationship between signal strength and sensed distance.

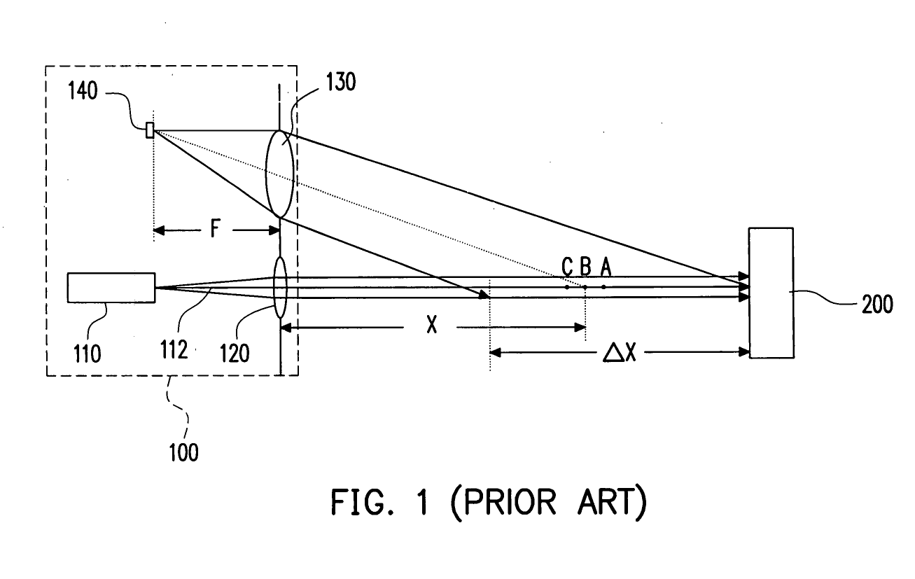

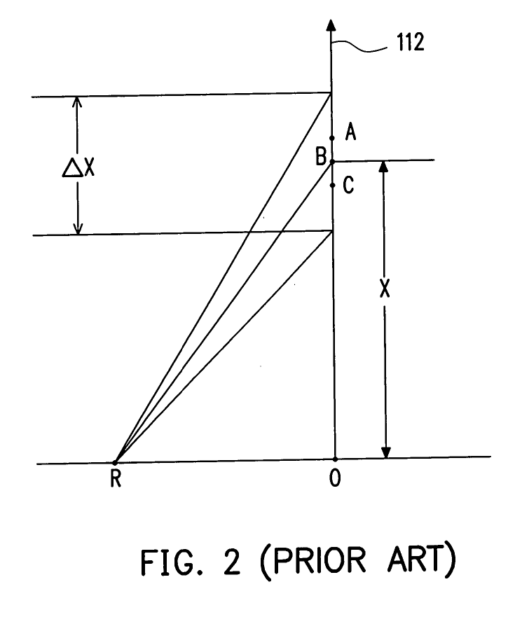

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

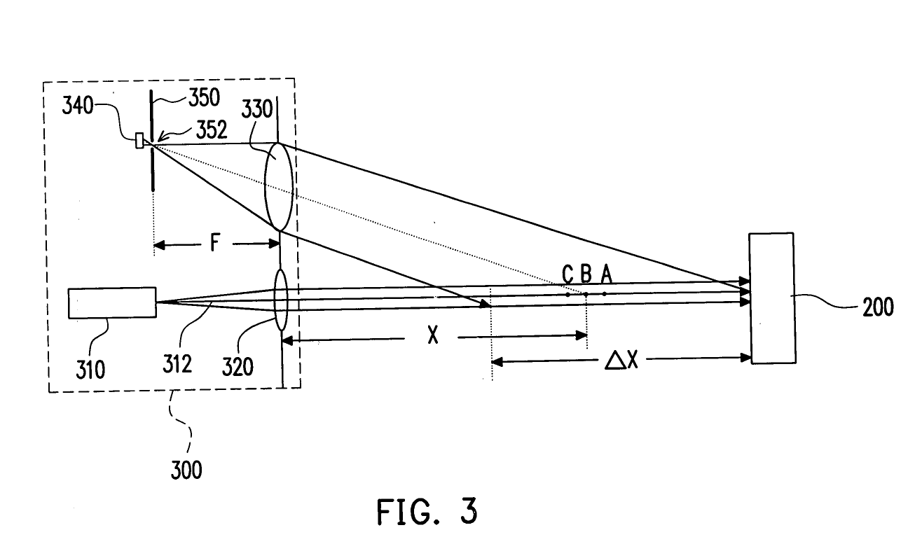

FIG. 3 is a side view of a short distance optical fixed-distance sensing apparatus according to one preferred embodiment of present invention. As shown in FIG. 3, the optical fixed-distance sensing apparatus 300 mainly comprises a light source 310, a collimator 320, a receiving lens 330, a photo sensor 340 and a light-shielding plate 350. The apparatus of present invention is designed to sense objects positioned at a distance between 10 dm to 50 dm or perform some other short distance measurement.

The light source 310 is adapted to project a beam of light 312. The light source 310 is a laser diode that produces a laser beam, for example. Obviously, anyone familiar with lighting technique may select other type of light beam instead of a laser beam.

The collimator is set up at a point along the path of the light beam 312 after the light source 310. The collimator positioned between the light source 210 and an object 200 is, for example, a collimating lens or other optical element that has a collimating capability. The light beam 312 from the light source 310 passes through the collimator 320, travels straight towards the object 200 and gets reflected therefrom.

It should be noted that if the light beam 312 projected from the light source 310 has a good collimating property, the collimator 320 can be dispensed with selectively.

The receiving lens 330 is set up at a point along the optical path of the light beam 312 after the object 200 for intercepting the light beam 312 reflected from the object 200. In this embodiment, the receiving lens 330 is a biconvex lens with a focal length F such that the light beam 312 passing through the receiving lens 330 will focus at the focal point, for example.

The light-shielding plate 350 is set up at a point along the path of the light-beam 312 after the receiving lens 330 such that the distance from the receiving lens 330 to the light-shielding plate 350 is equal to the focal length F of the receiving lens 330. Furthermore, the light-shielding plate 350 has an aperture 352 located at the focal point of the receiving lens 330. Since the light beam 312 will focus on the focal point after passing through the receiving lens 330, the light beam 312 has the smallest cross-sectional area at the focus point relative to other positions. Therefore, the aperture 352 on the light-shielding plate 350 is designed to have a shape identical to the light beam 312. In addition, the aperture 352 on the light-shielding plate 350 has a shape, which includes a circular, a polygonal or other geometric shape, dependent on the cross-section of the light beam 312.

The photo sensor 340 is set up at a point along the path of the light beam 312 after the light-shielding plate 350 for intercepting the light beam 312 passing through the aperture 352. In this embodiment, the photo sensor 340 is positioned at a slightly out-of-focus location. The photo sensor 340 is, for example, a light-emitting diode, a charge-coupled device (CCD), a complementary metal-oxide-semiconductor (CMOS) image sensor or other light sensitive device capable of intercepting the light beam 312.

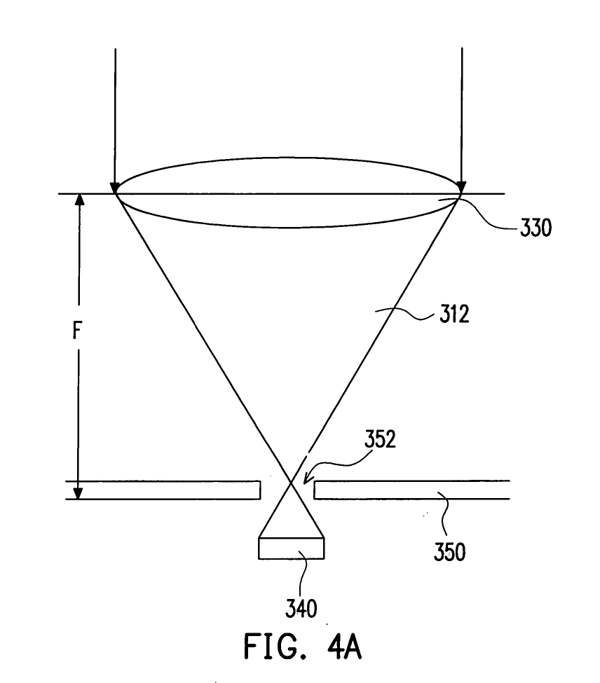

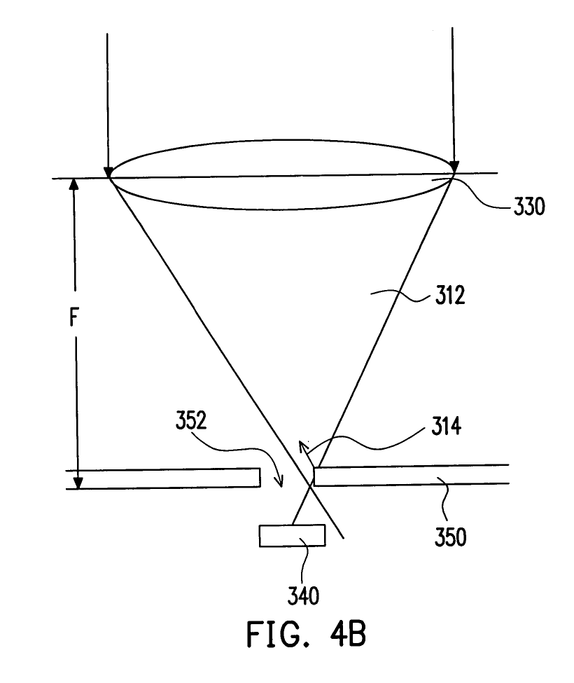

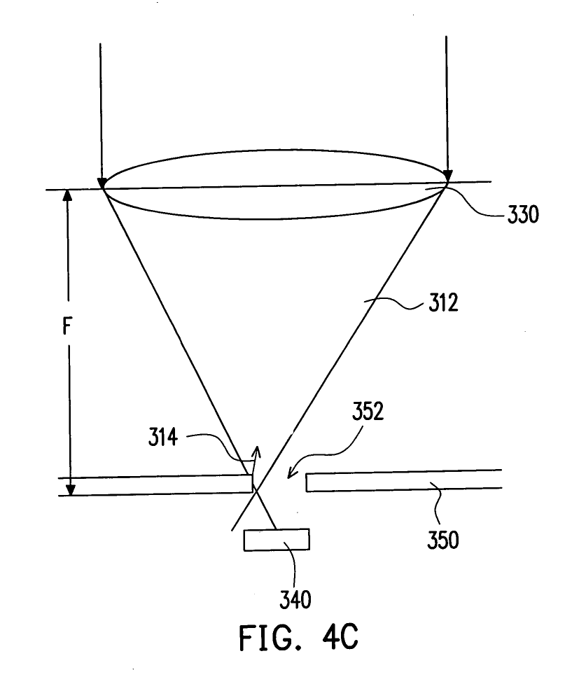

In this embodiment, the location of the light-shielding plate 350 and the design of the aperture 352 on the light-shielding plate 350 directly affects the distance measuring accuracy and sensitivity of the optical fixed-distance sensing apparatus 300. Such effects are explained in more detail by referring to FIGS. 4A, 4B and 4C.

FIGS. 4A, 4B and 4C show the relationship between the light-shielding plate and the light beam when the object in FIG. 3 is positioned at location B, location A and location C respectively. As shown in FIGS. 3 and 4A, when the object 200 is positioned at location B, the reflected light beam 312 from the object 200 passes through the receiving lens 330 and focus exactly on the aperture 352 of the light-shielding plate 350. Hence, the light-shielding plate 350 blocks none of the light beam 312 and the photo sensor 340 is able to pick up the strongest voltage signal V_{B}.

When the object 200 is positioned at location A (FIG. 4B) or at location C (FIG. 4C), the reflected light beam 312 from the object 200 is focused at a point slightly offset from the aperture 352 of the light-shielding plate 350 after passing through the receiving lens 330. Consequently, a portion of the light beam 312 is cut off by the light-shielding plate 350 to form a reflected beam 314. In other words, the voltage signals V_{A} and V_{C} picked up by the photo sensor 340 are smaller than the voltage signal V_{B}.

It should be noted that the size and shape of the aperture 352 on the light-shielding plate 350 is identical to or slightly larger than the smallest cross-section of the light beam 312 (the cross-sectional area at the focus after the light beam 312 passes through the receiving lens 330). Hence, the signal detected by the photo sensor 340 will be significantly different from the strongest signal voltage V_{B} if the object 200 is only slightly displaced from location B.

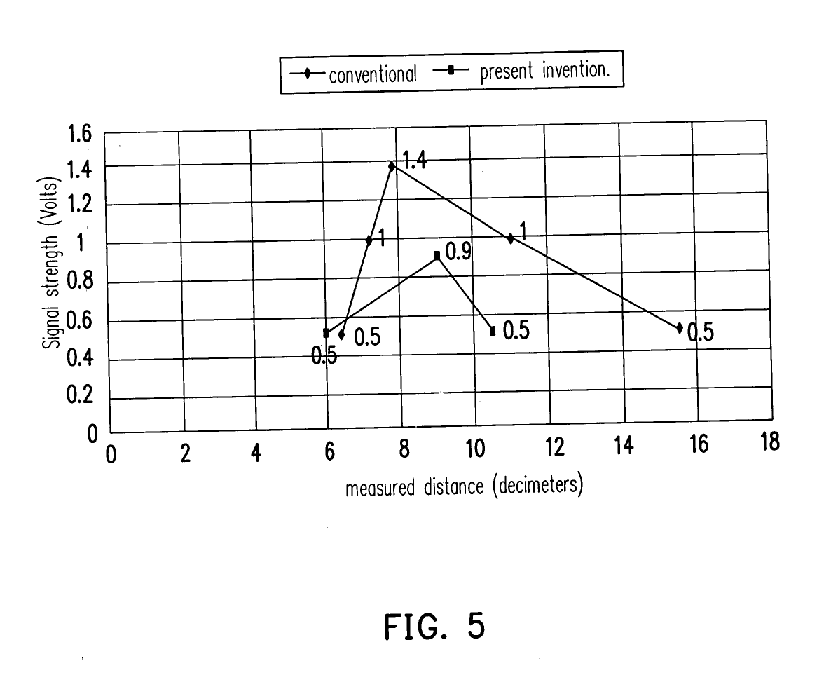

FIG. 5 is a graph showing the relationship between signal strength and sensed distance. As shown in FIG. 5, the conventional optical fixed-distance sensing apparatus has an object sensing range between 6.2 dm to 15.7 dm (a sensing range of about 10 dm). On the contrary, the present invention has an object sensing range between 6 dm to 10.5 dm (a sensing range of about 5 dm). If the cutoff signal strength is set to about 0.8V, the conventional optical fixed-distance sensing apparatus has an error range ΔX of about 6.5 dm but the optical fixed-distance sensing apparatus of the present invention has an error range ΔX of about 1dm only. In other words, the accuracy of distance measurement of the optical fixed-distance sensing apparatus is increased from ±3 dm to ±0.5 dm.

In summary, the optical fixed-distance sensing apparatus of present invention has at least the following advantages:

1. The error range of distance measurement can be reduced significantly so that overall precision of distance measurement is increased without a major modification of the optical fixed-distance sensing apparatus.

2. With a significant reduction of the error range of distance measurement, sensitivity of the optical fixed-distance sensing apparatus is raised.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical fixed-distance sensing apparatus, comprising:
a light source adapted to project a beam of light to an object and get a reflected beam therefrom;
a receiving lens set up at a point along the path of the light beam after the object;
a light-shielding plate set up at a point along the path of the light beam after the receiving lens, wherein the light-shielding plate has an aperture positioned at the focal point of the receiving lens; and
a photo sensor set up at a point along the path of the light beam after the light-shielding plate.

2. The optical fixed-distance sensing apparatus of claim 1, wherein the light source comprises a laser diode.

3. The optical fixed-distance sensing apparatus of claim 1, wherein the cross-sectional area of the light beam at the focal point of the receiving lens has a shape identical to the aperture.

4. The optical fixed-distance sensing apparatus of claim 3, wherein the aperture has a circular or a polygonal shape.

5. The optical fixed-distance sensing apparatus of claim 1, wherein the photo sensor is selected from a group consisting of light-emitting diode, charge-coupled device and complementary metal-oxide-semiconductor (CMOS) image sensor.

6. The optical fixed-distance sensing apparatus of claim 1, wherein the apparatus further comprises a collimator set up between the light source and the object.

7. The optical fixed-distance sensing apparatus of claim 6, wherein the collimator comprises a collimating lens.
